(19) United States
(12) Patent Application Publication
(10) Pub. No.: US 2026/0298660 A1
(43) Pub. Date: Oct. 1, 2026

(54) METHOD FOR GENERATING A MAP REPRESENTATION FOR A VEHICLE

(71) Applicant: Robert Bosch GmbH, Stuttgart (DE)

(72) Inventors: Hans-Georg Raumer, Hildesheim (DE); Max Kirstein, Hohenhameln - Ot Bruendeln (DE); Thomas Wenzel, Hamburg (DE); Thorben Funke, Sarstedt (DE)

(21) Appl. No.: 19/572,505

(22) Filed: Mar. 19, 2026

(30) Foreign Application Priority Data
Mar. 25, 2025 (DE) 10 2025 111 499.4

(51) Int. Cl. G01C 21/00; G06N 3/0499

(52) U.S. Cl. CPC G01C 21/3833; G01C 21/3807; G06N 3/0499

(57) ABSTRACT

A computer-implemented method for generating a map representation for a vehicle. The method includes: reception by an onboard map generation system of environmental sensor data of at least one environmental sensor of the vehicle, wherein the environmental sensor data at least partially represent an environment of the vehicle; ascertainment by the onboard map generation system of current behavioral information regarding a current average behavior of other road users in relation to traffic infrastructure in the vicinity of the vehicle on the basis of the environmental sensor data; and generation by the onboard map generation system of the map representation of the environment of the vehicle based on the environmental sensor data and the current behavioral information, wherein the map representation includes the behavioral information.

### CROSS REFERENCE

The present application claims the benefit under 35 U.S.C. § 119 of Germany Patent Application No. DE 10 2025 111 499.4 filed on Mar. 25, 2025, which is expressly incorporated herein by reference in its entirety.

### FIELD

The present disclosure relates to a method for generating a map representation for a vehicle.

### BACKGROUND INFORMATION

Certain methods for generating maps for vehicles are described in the related art.

It is an object of the present disclosure to provide an improved method for generating a map representation for a vehicle.

### SUMMARY

The object may be achieved by the method including certain features of the present disclosure. Advantageous embodiments are disclosed herein.

According to one aspect, a computer-implemented method for generating a map representation for a vehicle is provided. According to an example embodiment, the method comprises: reception by an onboard map generation system of environmental sensor data of at least one environmental sensor of the vehicle, wherein the environmental sensor data at least partially represent an environment of the vehicle; ascertainment by the onboard map generation system of current behavioral information regarding a current average behavior of other road users in relation to traffic infrastructure in the vicinity of the vehicle on the basis of the environmental sensor data; and generation by the onboard map generation system of the map representation of the environment of the vehicle based on the environmental sensor data and the current behavioral information, wherein the map representation comprises the behavioral information.

This can achieve a technical advantage that an improved method for generating a map representation for a vehicle can be provided. The map representation is generated by an onboard map generation system based on environmental sensor data of at least one environmental sensor of the vehicle. The map representation is thus created during operation of the vehicle by the onboard map generation system implemented in the vehicle.

In addition to the environmental sensor data, which at least partially represent the environment of the vehicle, the onboard map generation system also ascertains current behavioral information for map creation and integrates it as additional information into the map representation.

Behavioral information, within the meaning of the present application, is information about the average behavior of road users in the respective region of the traffic infrastructure within the respective environment of the vehicle. The behavior in question can be any behavior related to road traffic. Road users can be any type of road user from the related and prior art.

On the basis of the environmental sensor data, which represent a current state of the environment of the vehicle, the onboard map generation system ascertains corresponding current behavioral information and integrates it as additional information into the map representation. By actively ascertaining the behavioral information, it is possible to achieve the ascertained current behavioral information being adapted to the current state of the environment as represented by the environmental sensor data.

The map representation, within the meaning of the present application, is a map of the environment of the vehicle that is generated by the onboard map generation system executing an onboard map generation (OMG). The map representation represents the current state of the environment of the vehicle and comprises information based on the environmental sensor data of the at least one environmental sensor and is expanded by the current behavioral information ascertained by the onboard map generation system.

By taking into account the behavioral information ascertained on the basis of the environmental sensor data, the method according to the present disclosure can provide an improved map representation of the environment of the vehicle doing so during operation of the vehicle, which map representation is expanded with the current behavioral information.

Here, the electronic road map serves as a map prior, as is conventional for onboard map generation systems.

According to one example embodiment, the current behavioral information comprises at least one partial item of information from the following list: current average movement path, current average movement speed profile, current average braking point, current average lane change point.

This can achieve the technical advantage that, by means of the corresponding current behavioral information, the map representation generated by the onboard map generation system can be expanded with relevant information that describes the average behavior of road users. The behavioral information can be associated with corresponding positional information. The behavior can therefore be related to individual positions within the environment of the vehicle and within the traffic infrastructure.

According to one example embodiment, the method further comprises:

reception by the onboard map generation system of map data of an electronic road map, wherein the map data at least partially represent the traffic infrastructure within the environment of the vehicle, and wherein the map data comprise historical behavioral information; and wherein ascertainment by the onboard map generation system of the current behavioral information comprises:

updating the historical behavioral information to the current behavioral information taking into account the environmental sensor data, and/or wherein the historical behavioral information comprises at least one item of information from the following list: historical average movement path, historical average movement speed profile, historical average braking point, historical average lane change point.

As a result, a technical advantage can be achieved that, by taking into account the historical behavioral information of the electronic road map, a precise ascertainment of the current behavioral information based on the environmental sensor data and the map data is made possible. The current behavioral information is therefore not ascertained without a reference solely on the basis of the environmental sensor data. Instead, the historical behavioral information of the road map is updated taking into account the current environmental sensor data. If the environmental sensor data shows, for example, that the environment has changed with respect to the representation of the road map, for example a construction site is currently located there, the historical behavioral information of the road map will be correspondingly adapted to the current traffic situation. This makes a much more precise ascertainment of the current behavioral information possible.

According to one example embodiment, the historical average movement path is updated by regression to the current average movement path, and/or wherein the historical average movement speed profile is updated by regression to the current average movement speed profile, and/or wherein the historical average braking point is updated by classification to the current average braking point, and/or wherein the historical average lane change point is updated by classification to the current average lane change point.

This can achieve a technical advantage that regression and/or classification make possible a precise updating of the historical behavioral information of the road map.

According to one example embodiment, the ascertainment of the behavioral information is effected by a behavior prediction module of the onboard map generation system, and wherein the behavior prediction module comprises at least one trained artificial intelligence that is configured to predict the behavioral information.

As a result, a technical advantage can be achieved that, by means of the correspondingly trained artificial intelligences, a high-performance behavior prediction module is provided that is configured to effect a precise ascertainment of the current behavioral information on the basis of environmental sensor data and/or taking into account historical behavioral information of the electronic road map.

According to one example embodiment, the behavior prediction module comprises at least one regression multi-layer perceptron for updating the historical average movement path and/or the historical average movement speed profile, and/or wherein the behavior prediction module comprises at least one classification multi-layer perceptron for updating the historical average braking point and/or the historical average lane change point.

As a result, a technical advantage can be achieved that a precise updating of the historical behavioral information of the road map and a precise ascertainment of the current behavioral information are made possible.

According to one example embodiment, the environmental sensor data comprise image data and/or video data, and/or wherein the method further comprises:

conversion of the environmental sensor data into bird's-eye-view features by means of a transformer of a BEV backbone of the onboard map generation system;

extraction of map features on the basis of the bird's-eye-view features by means of a MAP head of the onboard map generation system; and generation of the map representation on the basis of the map features by means of a map prediction module of the onboard map generation system.

As a result, a technical advantage can be achieved that a precise map generation by the onboard map generation system on the basis of image data and/or video data of the environmental sensors is made possible.

According to one example embodiment, the method further comprises:

generation of feature vectors on the basis of the historical behavioral information of the map data by means of a map encoder of the onboard map generation system; and fusion of the feature vectors with the environmental sensor data.

As a result, a technical advantage can be achieved that, by generating the feature vectors on the basis of the historical behavioral information of the electronic road map, an updating of the historical behavioral information by the behavior prediction module is made possible.

By fusing the correspondingly converted historical behavioral information with the environmental sensor data, an improved integration of the behavioral information into the map representation generated on the basis of the environmental sensor data is made possible.

By fusing the corresponding feature vectors with the environmental sensor data, the behavior prediction module can take into account not only the information from the environmental sensor data but also the historical behavioral information in order to ascertain the current behavioral information.

In this case, the fusion of the feature vectors with the environmental sensor data is not intended to be limited to the pure environmental sensor data as provided by the environmental sensors. A fusion can also take place with the BEV features of the environmental sensor data or at an even later processing time.

According to one example embodiment, the fusion of the feature vectors with the environmental sensor data takes place in the map head, and/or wherein the fusion is effected via a cross-attention mechanism between the feature vectors and the BEV features of the environmental sensor data, and/or wherein the fusion of the feature vectors with the environmental sensor data takes place in the transformer of the BEV backbone, and/or wherein the feature vectors are fused with the BEV features generated by the BEV backbone via a cross-attention mechanism.

As a result, a technical advantage can be achieved that, by fusing the feature vectors with the environmental sensor data in the map head, a fusion of the feature vectors with the environmental sensor data that takes place as late as possible in the processing chain of the environmental sensor data is made possible. As a result, it can be achieved that previous processing steps of the environmental sensor data remain unaffected by the fusion with the feature vectors of the behavioral information.

By running the cross-attention mechanism to fuse the feature vectors with the BEV features of the environmental sensor data, a precise fusion can be achieved. By fusing the feature vectors with the environmental sensor data within a transformer of a BEV backbone in order to convert the environmental sensor data into the BEV features, it can be achieved that the feature vectors can be directly integrated into the BEV features to be generated on the basis of the environmental sensor data.

According to one example embodiment, generation of the feature vectors comprises the following:

generation of a sub-feature vector for each of the items of information of the behavioral information; and merging the sub-feature vectors to form a total feature vector by means of the map encoder.

This can achieve a technical advantage that, by generating the sub-feature vectors for each item of information of the historical behavioral information and by subsequently concatenating the plurality of sub-feature vectors into common feature vectors, a representation of the historical behavioral information of the road map in vector form that is as precise as possible is made possible.

According to one example embodiment, the map encoder comprises a plurality of artificial sub-networks, wherein each sub-network is configured to generate a corresponding sub-feature vector on the basis of the map data for an item of information of the behavioral information.

As a result, a technical advantage can be achieved that precise sub-feature vectors can be generated by the artificial sub-networks and generative neural networks of the map encoder on the basis of the different items of information of the historical behavioral information. By virtue of the correspondingly trained artificial intelligences, each item of information of the historical behavioral information of the electronic road map can be taken into account individually.

According to one example embodiment, the historical average movement path and the historical average movement speed profile are each in the form of line information, wherein the historical average braking point and the historical average lane change point are each in the form of point information, and wherein generation of the sub-feature vectors comprises: representing the line information as a plurality of items of point information and generating the sub-feature vectors as multidimensional vectors, wherein the dimension of a sub-feature vector corresponds to a sum of a number of items of point information and a number of features of the respective item of information, and wherein the item of information of the average movement speed profile comprises the features from the following list: average speed, speed variance, median speed, first and third quartiles of speed.

This can achieve a technical advantage that a precise representation of the historical behavioral information in the form of feature vectors is made possible.

According to one example embodiment, the behavior prediction module is integrated into the map head, and/or wherein the behavior prediction module is configured to update the historical behavioral information on the basis of the feature vectors.

This can achieve a technical advantage that a precise updating of the historical behavioral information of the electronic road map is made possible.

According to one aspect of the present disclosure, a computing unit is provided that is configured to carry out the method according to one of the above-described embodiments for generating a map representation for a vehicle.

According to one aspect of the present disclosure, a computer program product is provided which comprises commands that, when the program is executed by a data processing unit, cause the data processing unit to carry out the method according to one of the above-described embodiments for generating a map representation for a vehicle.

Example embodiments of the present disclosure are described with reference to the figures.

### BRIEF DESCRIPTION OF THE DRAWINGS

FIG. 1 is a graphical representation of an onboard map generation system for generating a map representation for a vehicle according to one example embodiment.

FIG. 2 is a graphical representation of map information for the onboard map generation system for generating the map representation according to a further example embodiment.

FIG. 3 is a schematic representation of a map encoder of the onboard map generation system according to one example embodiment.

FIG. 4 is a schematic representation of the behavior prediction module of the onboard map generation system according to one example embodiment.

FIG. 5 is a flowchart of a method for generating a map representation for a vehicle according to a further example embodiment.

FIG. 6 is a further flowchart of a method for generating a map representation for a vehicle according to a further example embodiment.

FIG. 7 is a schematic representation of a computer program product, according to an example embodiment.

### DETAILED DESCRIPTION OF EXAMPLE EMBODIMENTS

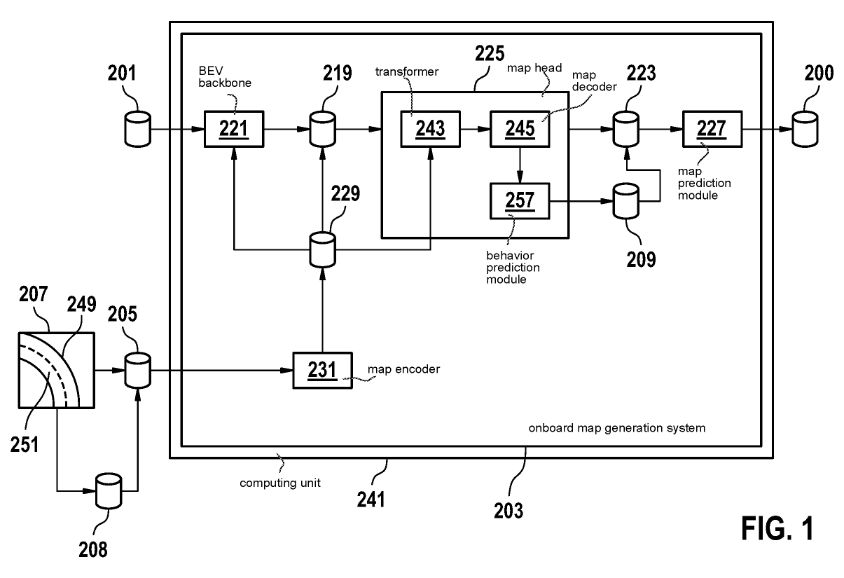

FIG. 1 is a graphical representation of an onboard map generation system 203 for generating a map representation 200 for a vehicle according to one embodiment.

According to the present disclosure, the onboard map generation system 203 is configured to generate a map representation 200 of the environment of the vehicle based on environmental sensor data 201 from at least one environmental sensor of the vehicle. The map representation 200 is generated during operation of the vehicle in the form of an onboard map generation.

The onboard map generation system 203 is further configured to generate current behavioral information 209 on the basis of the environmental sensor data 201 and to integrate this current behavioral information 209 into the map generation of the map representation 200.

The current behavioral information 209 describes a current average expected driving behavior of other road users within the environment of the vehicle.

According to one embodiment, this current behavioral information 209 comprises a current average movement path 211, a current average movement speed profile 213, a current average braking point 215 and/or a current average lane change point 217.

In the embodiment shown, the onboard map generation system 203 comprises a behavior prediction module 257.

The behavior prediction module 257 can be configured to predict the aforementioned average behavioral information 209 solely on the basis of the environmental sensor data 201 of the at least one environmental sensor of the vehicle. For this purpose, the behavior prediction module 257 can have at least one correspondingly trained artificial intelligence that is configured to predict the current behavioral information 209 on the basis of the environmental sensor data 201.

The at least one artificial intelligence may have been trained in accordance with the training methods mentioned in the related or prior art. The training may have been carried out in particular on correspondingly labeled environmental sensor data in which the aforementioned behavioral information 209, i.e. the average movement path, the average movement speed profile, the average braking point and/or the average lane change point, are labeled correspondingly.

However, in the embodiment shown, the behavior prediction module 257 is configured to take into account, in addition to the current environmental sensor data 201, historical behavioral information 208 from an electronic road map 207 in order to ascertain the current behavioral information 209. For this purpose, the onboard map generation system 203 is configured in the embodiment shown to receive map data 205 from a corresponding electronic road map 207. In this case, the map data 205 comprise at least the aforementioned historical behavioral information 208 and further represent traffic infrastructure within the environment of the vehicle.

The map data 205, or the electronic road map 207, are based on historical data from a plurality of trips by a plurality of vehicles and comprise properties that are typical of electronic road maps and from the related or prior art.

According to one embodiment, the historical behavioral information 208 comprises a historical average movement path 210 and/or a historical average movement speed profile 212 and/or a historical average braking point 214 and/or a historical average lane change point 216.

According to the embodiment shown, the behavior prediction module 257 is configured to perform an updating of the historical behavioral information 208 of the electronic road map 207 to the current behavioral information 209 on the basis of the environmental sensor data 201. To update the historical behavioral information 208 of the electronic road map 207, the behavior prediction module 257 takes into account a current state of the environment of the vehicle, represented by the current environmental sensor data 201, relative to the state of the environment of the vehicle represented by the electronic road map 207.

If the current traffic situation differs from the historical traffic situation represented in the electronic road map, for example due to the existence of a construction site that was not taken into account in the electronic road map and that influences the current driving behavior of road users, the behavior prediction module 257 is configured to adapt the historical behavioral information 208 of the electronic road map 207 to the current traffic situation of the current environmental sensor data 201 and to ascertain the current behavioral information 209 accordingly.

According to one embodiment, the behavior prediction module 257 is configured to update the historical average movement path 210 and/or the historical average movement speed profile 212 by a regression to the current average movement path 211 and/or the current average movement speed profile 213.

The behavior prediction module 257 can also be configured to update the historical average braking point 214 and/or the historical average lane change point 216 by performing a classification to the current average braking point 215 and/or the current average lane change point 217.

In this case, movement paths 211 are movement trajectories of the movements of the road users. Movement speed profiles 213 represent position-related speed information of the movements of the road users. Braking points 215 represent position-related information regarding speed reductions. Lane change points 217 represent position-related information regarding changing the traveled lane of a particular road.

The electronic road map 207 is based on historical data, which are based, for example, on historical trips by a plurality of different vehicles and on the environmental sensor data of the respective vehicles recorded during the trips. The electronic road map 207 thus represents a mapping of a traffic infrastructure. According to the present disclosure, the electronic road map 207 comprises the aforementioned historical behavioral information 208.

The historical behavioral information 208 comprises information regarding the average behavior of other road users in road traffic.

According to one embodiment, the historical behavioral information 208 comprises at least one item of information from the following list: historical average movement path 210, historical average movement speed profile 212, historical average braking point 214, historical average lane change point 216.

According to one embodiment, the environmental sensor data 201 comprise image data and/or video data.

In the embodiment shown, the onboard map generation system 203 comprises a BEV backbone 221. The BEV backbone 221 is configured to convert the environmental sensor data 201 into BEV features 219, i.e. into bird's-eye-view features.

In the embodiment shown, the onboard map generation system 203 further comprises a map head 225 having a transformer 243 and a map decoder 245. In this case, the map head 225 is configured to generate map features 223 on the basis of the BEV features 219 and the environmental sensor data 201.

In the embodiment shown, the onboard map generation system 203 further comprises a map prediction module 227. In this case, the map prediction module 227 is configured to generate the map representation 200 on the basis of the map features 223.

In the embodiment shown, the onboard map generation system 203 further comprises a map encoder 231. In this case, the map encoder 231 is configured to generate feature vectors 229 on the basis of the map data 205 of the electronic road map 207 and the comprised historical behavioral information 208. In this case, the feature vectors 229 are in the form of multidimensional vectors and comprise the information from the map data 205, in particular the behavioral information 209.

In order to integrate the historical behavioral information 208 of the electronic road map 207, the onboard map generation system 203 is configured to fuse the feature vectors 229 with the environmental sensor data 201.

In this case, the electronic road map 207 serves as a map prior, as is conventional for onboard map generation systems.

FIG. 1 shows three different fusion alternatives A, B, C.

In fusion variant A, the feature vectors 229 representing the historical behavioral information 208 are fused with the environmental sensor data 201 within the BEV backbone 221.

The fusion of the environmental sensor data 201 with the feature vectors 229 within the BEV backbone 221 can be carried out analogously to Luo et al. (K. Z. Luo, X. Weng, Y. Wang, S. Wu, J. Li, K. Q. Weinberger, Y. Wang, and M. Pavone, "Augmenting lane perception and topology understanding with standard definition navigation maps," in 2024 IEEE International Conference on Robotics and Automation (ICRA), pp. 4029–4035, IEEE, 2024).

In fusion variant B, the feature vectors 229 are directly fused with the BEV features 219 of the environmental sensor data 201.

The fusion of the feature vectors 229 with the BEV features 219 can be carried out analogously to Wu et al. (H. Wu, Z. Zhang, S. Lin, T. Qin, J. Pan, Q. Zhao, C. Xu, and M. Yang, "Blos-bev: Navigation map enhanced lane segmentation network, beyond line of sight," in 2024 IEEE Intelligent Vehicles Symposium (IV), pp. 3212–3219, IEEE, 2024).

In fusion variant C, the feature vectors 229 are fused with the environmental sensor data 201 within the transformer 243 of the map head 225. The fusion of the feature vectors 229 with the environmental sensor data 201 within the transformer 243 of the map head 225 can be carried out by means of a cross-attention mechanism.

According to one embodiment, the transformation of the environmental sensor data 201 into the BEV features 219 by the BEV backbone 221 takes place analogously to Yang et al. (C. Yang, Y. Chen, H. Tian, C. Tao, X. Zhu, Z. Zhang, G. Huang, H. Li, Y. Qiao, L. Lu, et al., "Bevformer v2: Adapting modern image backbones to bird’s-eye-view recognition via perspective supervision," in Proceedings of the IEEE/CVF Conference on Computer Vision and Pattern Recognition, pp. 17830–17839, 2023).

In FIG. 1, the onboard map generation system 203 is shown to be executable on a computing unit 241.

In the embodiment shown, the behavior prediction module 257 is applied to the map features 223 provided by the map decoder 254 to thereby effect, on the basis thereof, an updating of the historical behavioral information 208 of the electronic road map 207.

In the embodiment shown, the behavior prediction module 257 is integrated into the map head 225.

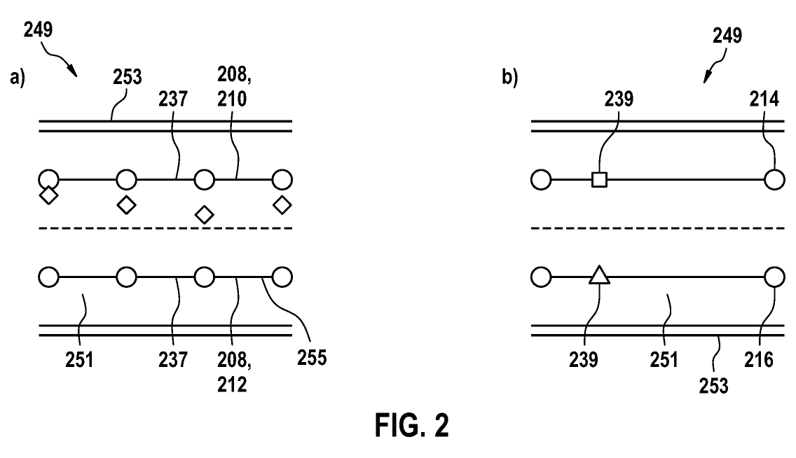

FIG. 2 shows graphical representations of map information for the onboard map generation system 203 for generating the map representation 200 according to a further embodiment.

In graphic a), a historical average movement path 210, a historical average movement speed profile 212 as possible items of information of the historical behavioral information 208, and a centerline 255 are shown. The centerline 255 represents the course of the center of the depicted road 249 or lane 251.

The historical average movement path 210 represents a deviation from the centerline 255 of the actual positions of the vehicles traveling on the road.

The historical average movement path 210 is shown in graphic a) as line information 237 and the historical average movement speed profile 212 is shown as an item of attribute information that is position-dependently associated with the average movement path 211 as additional information.

The average movement path 211 here represents a graphical course of an average movement along the road 249.

The average movement speed profile 213 is a graphical representation of an average movement speed along the road 249.

The illustrated items of information of the historical behavioral information 208 are each based on historical data from multiple passes of a plurality of vehicles along the road 249.

Graphic b) shows, as two further items of information of the historical behavioral information 208: a historical average braking point 214 and a historical average lane change point 216.

In this case, the historical average braking point 214 represents an item of position information at which the road users typically perform a braking maneuver when moving along the road 249.

The historical average lane change point 216 accordingly represents an item of position information at which the road user on average performs a lane change between different lanes 251 of the road 249.

The historical average braking point 214 and the historical average lane change point 216 are each represented as items of point information 239.

To generate the feature vectors 229 on the basis of the item of information of the historical behavioral information 209 represented as line information 237, the line information 237 is sampled according to a sampling mechanism and parametrized in the form of a plurality of items of point information 239.

To generate the feature vectors 229, a line of uniform length is converted into a predefined number of items of point information 239 for each item of line information 237.

By converting the items of line information 237 for each feature vector 229 into a uniform number of items of point information 239, it is possible to provide the respective sub-feature vectors, which represent the respective item of information of the behavioral information 209, with a uniform dimension.

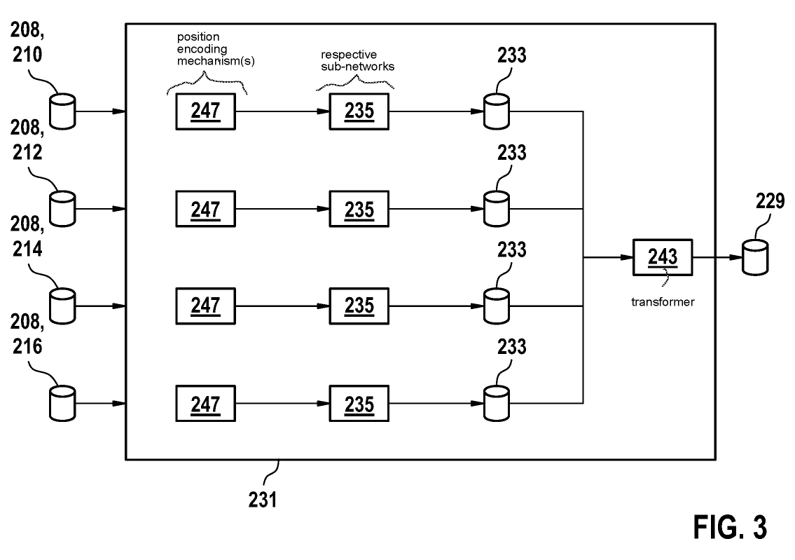

FIG. 3 is a schematic representation of a map encoder 231 of the onboard map generation system 203 according to one embodiment.

In the embodiment shown, the map encoder 231 comprises four sub-networks 235, each of which is configured as a multilayer perceptron MLP. The sub-networks 235 serve to generate individual sub-feature vectors 233 for the individual items of information of the historical behavioral information 208.

For this purpose, the four different items of information of the historical behavioral information 208 shown in the illustrated examples, in the form of the historical average movement path 210, the historical average movement speed profile 212, the historical average braking point 214 and the historical average lane change point 216, are provided to the map decoder 231 as input data.

The individual items of information are first preprocessed by a position encoding mechanism 247 and then provided to the respective sub-networks 235.

Said sub-networks create a corresponding sub-feature vector 233 for each item of information.

The four sub-feature vectors 233 are subsequently concatenated and provided to a transformer 243 of the map encoder 231.

The transformer 243 subsequently provides a summary behavior vector 229, which comprises the four items of information of the historical behavioral information 208.

For each piece of line information 237, for example the historical average movement path 210 or the historical average movement speed profile 212, a fixed number nₗᵢₙₑₛ of items of point information 239 are first created for lines of uniform length.

Next, a sub-feature vector 233 of dimension nₗᵢₙₑₛₓ is used (kₚₒₛ + k_{feature}), where kₚₒₛ is the feature dimension of the position encoding 247 and k_{feature} is the feature dimension of the input feature, i.e. the average movement path 211 or the average movement speed profile 213.

In the case of the historical average movement speed profile 212, k_{feature} is equal to 5, where the dimension of 5 is obtained from the average speed, the speed variance, the median speed, and the first and third quartiles of the speed.

For the historical average movement path 210, k_{feature} is equal to 1 and corresponds to the variance at the respective location.

By executing the particular sub-network 235 and performing a corresponding reshaping operation, the sub-feature vector 233 of dimension k is ascertained.

For the items of point information 239, the historical average braking point 214 and the historical average lane change point 216, the input vector for the sub-network 235 has the dimension kₚₒₛ + k_{feature}. In this case, k_{feature} is equal to 1, i.e. the frequency of the particular historical average braking point 214 or historical lane change point 216.

By executing the particular sub-network 235 on the correspondingly generated input vectors, the particular sub-feature vector 233 with the dimension k is then generated.

Next, the sub-feature vectors 233 are concatenated to yield n_{behavior} x k_{,} where n_{behavior} is the number of items of information of the behavioral information 209.

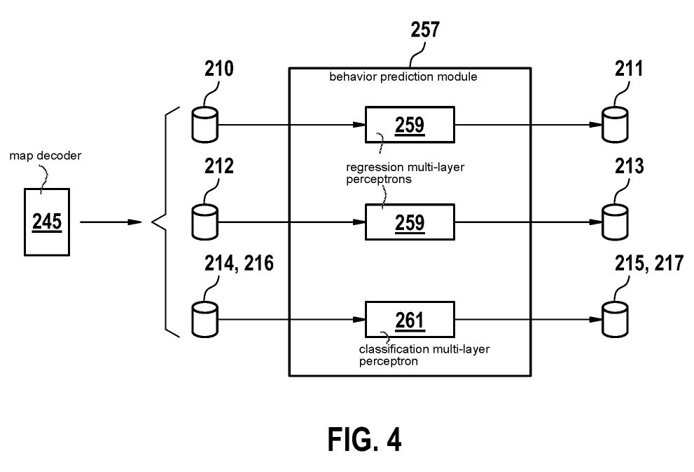

FIG. 4 is a schematic representation of a behavior prediction module of the onboard map generation system 203 according to one embodiment.

In the embodiment shown, the behavior prediction module 257 comprises two regression multi-layer perceptrons 259 and one classification multi-layer perceptron 261.

On the basis of the two regression multi-layer perceptrons 259, the behavior prediction module 257 is configured to ascertain the current average movement path 211 and the current average movement speed profile 213, on the basis of the historical average movement path 210 and historical average movement speed profile 212 comprised in the map features 223 of the map decoder 245, by executing two separate regression procedures.

By means of the classification multi-layer perceptron 261, the behavior prediction module 257 is configured to ascertain the current average braking point 215 and the current average lane change point 217, on the basis of the historical average braking point 214 and the historical average lane change point 216, by executing a classification procedure.

Not only in the regression procedure but also in the classification procedure, is the information of the environmental sensor data 201 contained in the map features 223 provided by the map decoder 245 also taken into account for performing the updating of the individual items of information of the historical behavioral information 208.

In this case, the regression multi-layer perceptrons 259 can be effected by using least squares loss functions at the interpolation points of the centerlines 255. The movement speed profile 213 can be taken into account here as attribute information and can also be predicted at the interpolation points of the centerline 255.

The discrete items of attribute information of the average braking point 215 and the average lane change point 217 are predicted according to classification approaches at the interpolation points of the centerline 255. In this case, the classification multi-layer perceptron 261 is trained taking into account a cross-entropy loss function.

The behavior prediction module 257 is trained by optimizing a convex combination of the individual loss functions of the various multi-layer perceptrons 259, 261.

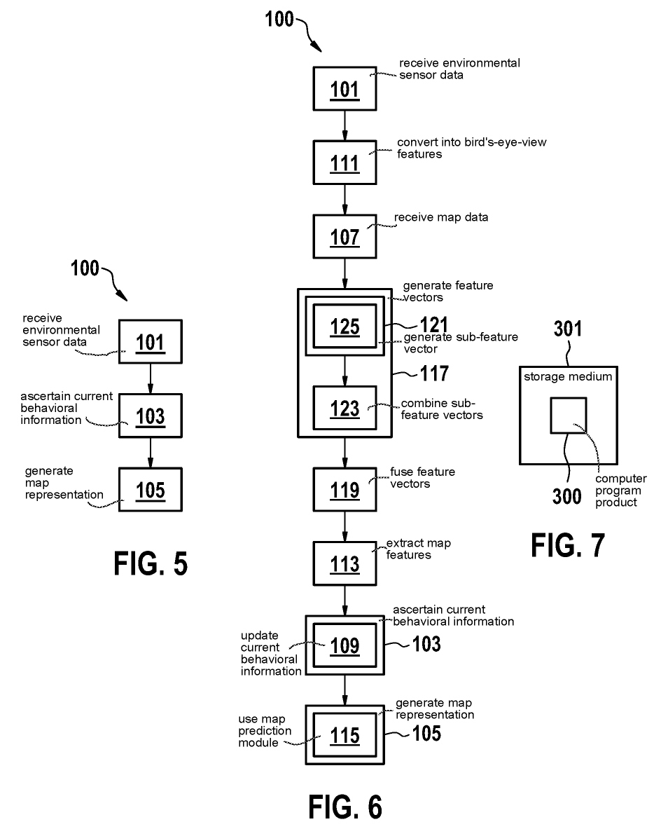

FIG. 5 is a flowchart of a method 100 for generating a map representation 200 for a vehicle according to a further embodiment.

To generate a map representation 200 for a vehicle, the onboard map generation system 203, in a method step 101, first receives environmental sensor data 201 of the at least one environmental sensor of the vehicle. In this case, the environmental sensor data 201 at least partially represent the environment of the vehicle.

In a further method step 103, current behavioral information 209 is ascertained by the onboard map generation system 203 on the basis of the environmental sensor data 201.

In a further method step 105, the map representation 200 is generated by the onboard map generation system 203 on the basis of the environmental sensor data 201 and the current behavioral information 209 of the map data 205 of the electronic road map 207.

In this case, the map representation 200 comprises the current behavioral information 209. Here, the map representation 200 is generated as an onboard map generation and is performed during operation of the vehicle.

FIG. 6 is a further flowchart of the method 100 for generating a map representation 200 for a vehicle according to a further embodiment.

The embodiment shown is based on the embodiment in FIG. 4 and comprises all the method steps described there.

In the embodiment shown, in a method step 111 the received environmental sensor data 201 are converted into bird's-eye-view features 219 by means of a transformer 243 of the BEV backbone 221 of the onboard map generation system 203.

In a further method step 107, the onboard map generation system 203 receives map data 205 of an electronic road map 207.

The electronic road map 207 serves as a map prior and maps the traffic infrastructure within the environment of the vehicle. The map data 205 comprise historical behavioral information 208.

In a further method step 117, the feature vectors 229 are generated by the map encoder 231 of the onboard map generation system 203 on the basis of the historical behavioral information 208 of the map data 205 of the electronic road map 207.

For this purpose, in a method step 121, a sub-feature vector 233 is generated for each of the items of information of the historical behavioral information 208.

To this end, in a method step 125, the items of information of the historical behavioral information 208 represented as line information 237 are each represented as a plurality of items of point information 239, and the sub-feature vectors 233 are generated as multidimensional vectors, wherein the dimension of a sub-feature vector 233 corresponds to a sum of the number of items of point information 239 and a number of features of the particular item of information.

In a further method step 123, the sub-feature vectors 233 are combined by the map encoder 231 to form a total feature vector 229.

In a further method step 119, the feature vectors 229 are fused with the environmental sensor data 201.

In a further method step 113, map features 223 are extracted, on the basis of the bird's-eye-view features 219, by means of a map head 225 of the onboard map generation system 203.

In a further method step 115, the map representation 200 is generated, on the basis of the map features 223, by means of a map prediction module 227 of the onboard map generation system 203.

In the embodiment shown, to ascertain 103 the current behavioral information 209, in a method step 109, the historical behavioral information 208, taking into account the current environmental sensor data 201, is updated to the current behavioral information 209.

The historical average movement path 210 can here be updated to the current average movement path 211 by regression. The historical average movement speed profile 212 can likewise be updated to the current average movement speed profile 213 by regression. The historical average braking point 214 can be updated to the current average braking point 215 by classification. The historical average lane change point 216 can likewise be updated to the current average lane change point 217 by classification.

FIG. 7 is a schematic representation of a computer program product 300 comprising commands that, when the program is executed by a data processing unit, cause the data processing unit to carry out the method 100 for generating a map representation 200 for a vehicle.

In the embodiment shown, the computer program product 300 is stored on a storage medium 301. The storage medium 301 can be any storage medium from the related or prior art.

What is claimed is:

1. A computer-implemented method for generating a map representation for a vehicle, the method comprising the following steps:
receiving, by an onboard map generation system, environmental sensor data of at least one environmental sensor of the vehicle, wherein the environmental sensor data at least partially represent an environment of the vehicle;
ascertaining, by the onboard map generation system, current behavioral information regarding a current average behavior of other road users in relation to traffic infrastructure in a vicinity of the vehicle, based on the environmental sensor data; and
generating, by the onboard map generation system, the map representation of the environment of the vehicle based on the environmental sensor data and the current behavioral information, wherein the map representation includes the current behavioral information.

2. The method according to claim 1, wherein the current behavioral information includes at least one item of information from the following list: average movement path, average movement speed profile, average braking point, average lane change point.

3. The method according to claim 1, further comprising:
receiving, by the onboard map generation system, map data of an electronic road map, wherein the map data at least partially represent traffic infrastructure within the environment of the vehicle, and wherein the map data includes historical behavioral information;
wherein the ascertainining, by the onboard map generation system, of the current behavioral information includes updating the historical behavioral information to the current behavioral information taking into account the environmental sensor data.

4. The method according to claim 1, further comprising:
receiving, by the onboard map generation system, map data of an electronic road map, wherein the map data at least partially represent traffic infrastructure within the environment of the vehicle, and wherein the map data includes historical behavioral information;
wherein the historical behavioral information includes at least one item of information from the following list: historical average movement path, historical average movement speed profile, historical average braking point, historical average lane change point.

5. The method according to claim 4, wherein at least one of:
the historical average movement path is updated by regression to a current average movement path,
the historical average movement speed profile is updated by regression to a current average movement speed profile,
the historical average braking point is updated by classification to a current average braking point, or
the historical average lane change point is updated by classification to a current average lane change point.

6. The method according to claim 5, wherein the ascertaining of the current behavioral information is effected by a behavior prediction module of the onboard map generation system, and wherein the behavior prediction module includes at least one trained artificial intelligence that is configured to predict the current behavioral information.

7. The method according to claim 6, wherein at least one of:
the behavior prediction module includes at least one regression multi-layer perceptron for updating at least one of: the historical average movement path, or the historical average movement speed profile, or
the behavior prediction module includes at least one classification multi-layer perceptron for updating at least one of: the historical average braking point, or the historical average lane change point.

8. The method according to claim 1, wherein the environmental sensor data includes at least one of: image data, or video data.

9. The method according to claim 4, further comprising:
converting the environmental sensor data into bird's-eye-view (BEV) features using a transformer of a BEV backbone of the onboard map generation system,
extracting map features based on the BEV features using a map head of the onboard map generation system, and
generating the map representation based on the map features using a map prediction module of the onboard map generation system.

10. The method according to claim 9, further comprising:
generating feature vectors based on the historical behavioral information of the map data using a map encoder of the onboard map generation system.

11. The method according to claim 10, further comprising:
fusing the feature vectors with the environmental sensor data, wherein at least one of:
the fusing of the feature vectors with the environmental sensor data takes place in the map head,
the fusing is effected via a cross-attention mechanism between the feature vectors and the BEV features, or
the fusing of the feature vectors with the environmental sensor data takes place in the transformer of the BEV backbone.

12. The method according to claim 10, wherein the feature vectors are fused with the BEV features generated by the BEV backbone via a cross-attention mechanism.

13. The method according to claim 10, wherein the generating of the feature vectors includes:
generating a sub-feature vector for each item of information of the current behavioral information, and
combining the sub-feature vectors into a total feature vector using the map encoder.

14. The method according to claim 10, wherein the map encoder includes a plurality of artificial sub-networks, wherein each sub-network is configured to generate, based on the map data, a corresponding sub-feature vector for an item of information of the historical behavioral information.

15. The method according to claim 13, wherein the historical average movement path and the historical average movement speed profile are each in a form of line information, wherein the historical average braking point and the historical average lane change point are each in a form of point information, and wherein generating the sub-feature vectors includes:
representing the line information as a plurality of items of point information, and generating the sub-feature vectors as multidimensional vectors, wherein a dimension of each sub-feature vector corresponds to a sum of a number of items of point information and a number of features of a respective item of information, and wherein an item of information of an average movement speed profile includes at least one feature from the following list: average speed, speed variance, median speed, first quartile of speed, third quartile of speed.

16. The method according to claim 9, wherein the ascertaining of the current behavioral information is effected by a behavior prediction module of the onboard map generation system, and wherein the behavior prediction module includes at least one trained artificial intelligence that is configured to predict the current behavioral information, and wherein at least one of:
the behavior prediction module is integrated into the map head, or
the behavior prediction module is configured to update the historical behavioral information based on the feature vectors.

17. A computing unit configured to generate a map representation for a vehicle, the computing unit configured to perform the following steps comprising:
receiving, by an onboard map generation system, environmental sensor data of at least one environmental sensor of the vehicle, wherein the environmental sensor data at least partially represent an environment of the vehicle;
ascertaining, by the onboard map generation system, current behavioral information regarding a current average behavior of other road users in relation to traffic infrastructure in a vicinity of the vehicle, based on the environmental sensor data; and
generating, by the onboard map generation system, the map representation of the environment of the vehicle based on the environmental sensor data and the current behavioral information, wherein the map representation includes the current behavioral information.

18. A non-transitory computer-readable medium on which is stored a computer program productincluding commands for generating a map representation for a vehicle, the commands, when executed by a data processor, causing the data processor to perform the following steps:
receiving, by an onboard map generation system, environmental sensor data of at least one environmental sensor of the vehicle, wherein the environmental sensor data at least partially represent an environment of the vehicle;
ascertaining, by the onboard map generation system, current behavioral information regarding a current average behavior of other road users in relation to traffic infrastructure in a vicinity of the vehicle, based on the environmental sensor data; and
generating, by the onboard map generation system, the map representation of the environment of the vehicle based on the environmental sensor data and the current behavioral information, wherein the map representation includes the current behavioral information.
